(19) United States
(12) Patent Application Publication
(10) Pub. No.: US 2010/0091102 A1
(43) Pub. Date: Apr. 15, 2010

(54) Toy camera set

(76) Inventor: Elliot Rudell, Torrance, CA (US)

Correspondence Address: IRELL & MANELLA LLP, 1800 AVENUE OF THE STARS, SUITE 900, LOS ANGELES, CA, 90067, US

(21) Appl. No.: 12/590,213

(22) Filed: Nov. 2, 2009

Related U.S. Application Data
(63) Continuation-in-part of application No. 11/173,549, filed on Jul. 1, 2005, now abandoned.
(60) Provisional application No. 60/585,034, filed on Jul. 1, 2004.

(51) Int. Cl. H04N 7/18; A63H 33/22; H04N 5/335

(52) U.S. Cl. 348/79; 446/219; 348/294; 348/E07.085; 348/E05.091

(57) ABSTRACT

A toy camera set. The camera set includes a camera that can be attached to a variety of different toy optical accessories. By way of example, the toy optical accessories may include a toy microscope, a toy periscope, or a toy binocular. The camera can be used to take a picture through the microscope, etc. The camera can be attached to one accessory and then attached to another accessory so that a single camera can be used with a number of toy optical devices. The kit includes an instruction guide that instructs a user how to attach the various toy accessories to the camera.

### REFERENCE TO CROSS-RELATED APPLICATIONS

This application is a continuation-in-part of application Ser. No. 11/173,549 filed on Jul. 1, 2005 and claims priority to provisional Application No. 60/585,034, filed on Jul. 1, 2004.

### BACKGROUND OF THE INVENTION

1. Field of the Invention

The present invention relates to a toy camera set.

2. Prior Art

There have been marketed various toy optical products such as toy microscopes and toy binoculars. To date there has not been a product that would allow a user to conveniently take a picture of the object being viewed through different optical devices such as a toy microscope or a toy binocular or similar toy optical viewing device. It would be desirable to provide a product that would allow the user to take a picture of what is being viewed through, for example a toy microscope, so that the user can capture and review the object. It would be desirable if such a product were relatively inexpensive to produce and easy to use. It would be further desirable, as an educational activity system, for the imaging device to be readily adaptable to accept multiple special imaging components such as a telescope, or microscope or periscope.

### BRIEF SUMMARY OF THE INVENTION

A toy camera kit that includes a camera, an instruction guide and a toy optical accessory that can be attached to the camera.

### BRIEF DESCRIPTION OF THE DRAWINGS

FIG. 1 is a perspective view of a toy camera kit;

FIG. 2 is a perspective view of a camera attached to a toy microscope of the kit;

FIG. 3 is a perspective view of the camera attached to a toy binocular of the kit;

FIG. 4 is a perspective view of the camera attached to a periscope of the kit;

FIG. 5 is a perspective view of the camera attached to an underwater periscope of the kit;

FIG. 6 is a perspective view of the camera being attached a toy accessory.

FIG. 7 is a perspective view of an alternate embodiment for attaching the camera to an accessory; and,

FIGS. 8A-C are illustrations of an instruction guide that show a user how to attach a top periscope to the toy camera.

### DETAILED DESCRIPTION

Disclosed is a toy camera kit. The camera kit includes a camera that can be attached to a variety of different toy optical accessories. By way of example, the toy optical accessories may include a toy microscope, a toy periscope, or a toy binocular. The camera can be used to take a picture through the microscope, etc. The camera can be attached to one accessory and then easily removed from that first accessory and then attached to another accessory so that a single camera can be used with a number of toy optical devices. The kit includes an instruction guide that instructs a user how to attach the various toy accessories to the camera, and how to utilize the camera when coupled to said accessory.

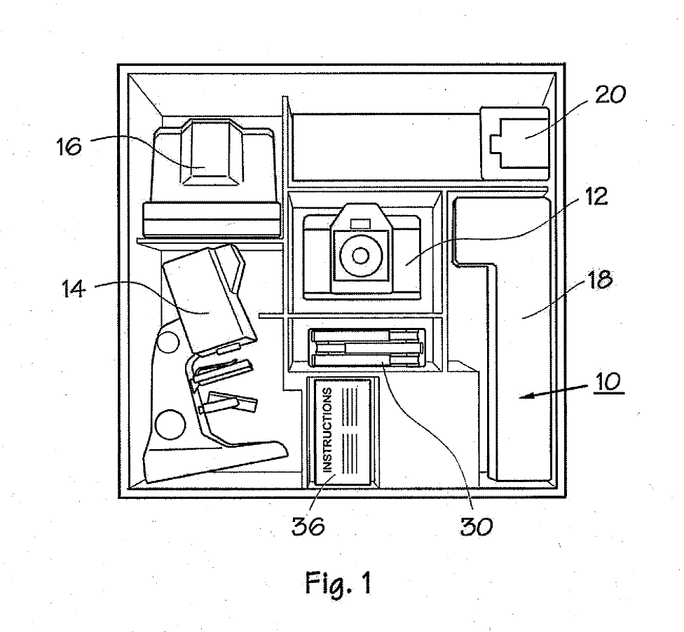

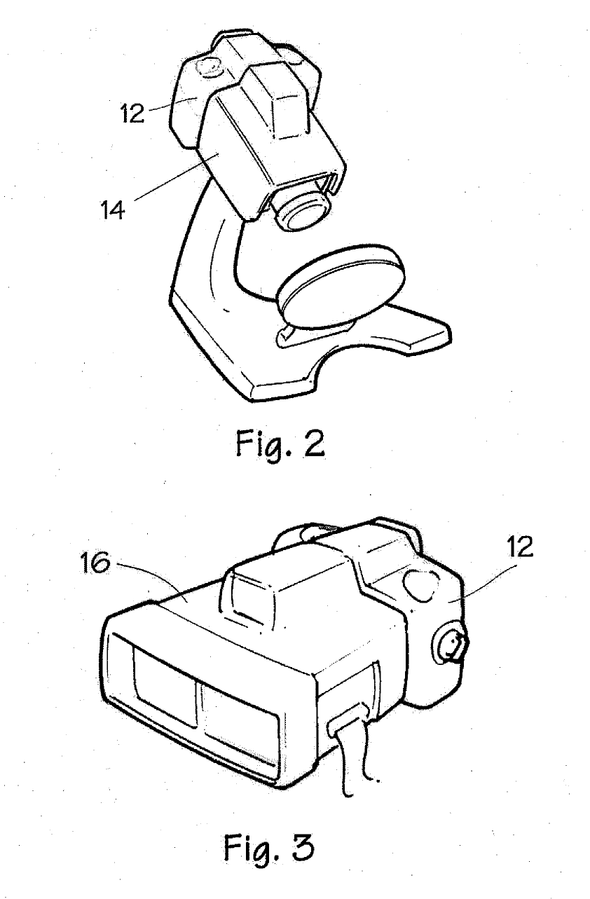

Referring to the drawings more particularly by reference numbers, FIG. 1 shows a toy camera kit 10. The camera kit 10 contains a camera 12 and a plurality of toy optical accessories 14, 16, 18 and 20. The toy optical accessories may include a toy microscope 14 that contains lenses and mirrors (not shown) that can magnify something located in the object field of the microscope 14. The camera 12 can be attached to the image field of the microscope 14 as shown in FIG. 2. The user can take a picture of a specimen with the camera 12. The housing of the toy microscope 14 is preferably constructed from a relatively lightweight and inexpensive plastic material, such as high impact styrene or abs plastic.

The camera 12 can be attached to a toy standard or stereoscopic binocular 16 as shown in FIG. 3. The toy binocular 16 contains lenses, etc. used to magnify single or dual distant images. The housing of the toy binocular 16 is preferably constructed from a relatively lightweight and inexpensive plastic material. The camera 12 can be used to take pictures through the binoculars 16. The binoculars 16 can act as a lens for the camera 12.

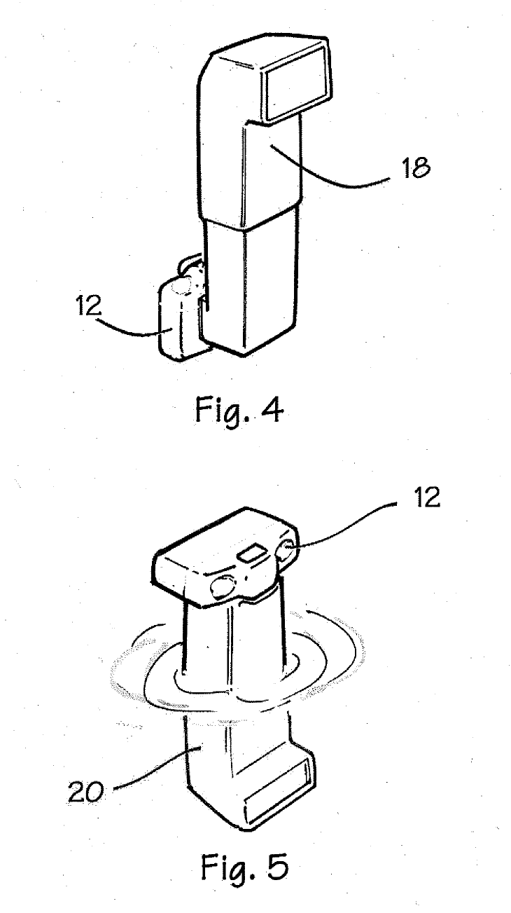

The camera 12 may also be attached to a periscope 18, or an underwater periscope 20, as shown in FIGS. 4 and 5, respectively. The periscopes 18 and 20 may contain lenses and mirrors enclosed by a plastic housing. The camera 12 can be used to take pictures thru the periscopes 18 and 20.

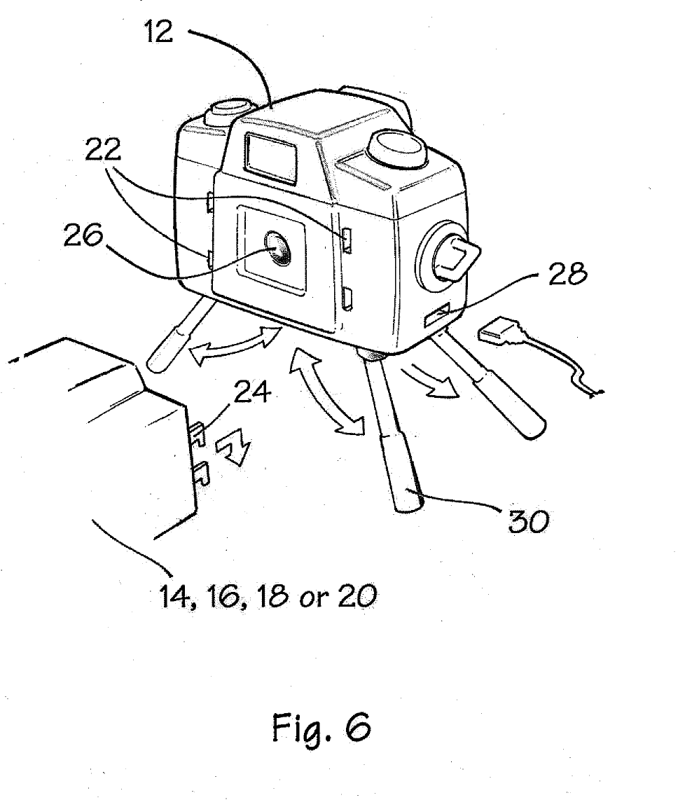

Key to the compatibility between the camera 12 and its accessories 14, 16, 18 and 20, is a coordinated attachment means to allow the child to easily attach and detach the accessories from the camera. By way of example and as shown in FIG. 6 the camera 12 may have a pair of slots 22 that receives corresponding snap-on hooks 24 that extend from each toy accessory 14, 16, 18 and 20. The slots 22 and hooks 24 allow the camera 12 to be easily attached and detached from each accessory 14, 16, 18 and 20 without the use of any tools such as a screwdriver, etc., while assuring the necessary proper alignment between the camera 12 and said accessories.

The camera 12 is preferably of the digital type with a digital image sensor 26. Digital cameras typically have a connector 28 that can be connected to a personal computer or other such device so that the captured images can be downloaded to the computer. By way of example, the connector 28 may be of the USB type. The camera 12 may also have a detachable memory card (not shown) that can be plugged into a computer, etc. Digital cameras 12 have screens that allow the user to view the image that can be captured. Thus when the camera is attached to an optical accessory 14, 16, 18 and 20, the user can see the image viewed thru the accessory.

The camera 12 can be attached to a toy tripod 30. The toy tripod 30 may be three separate legs that are attached to the bottom of the camera 12. Alternatively, the tripod feature may be integral to the bottom of the camera 12, and thus non-removable from the camera 12.

The camera kit 10 may include instructions 32 that instruct a user on how to attach the accessories 14, 16, 18 and 20 to the camera 12.

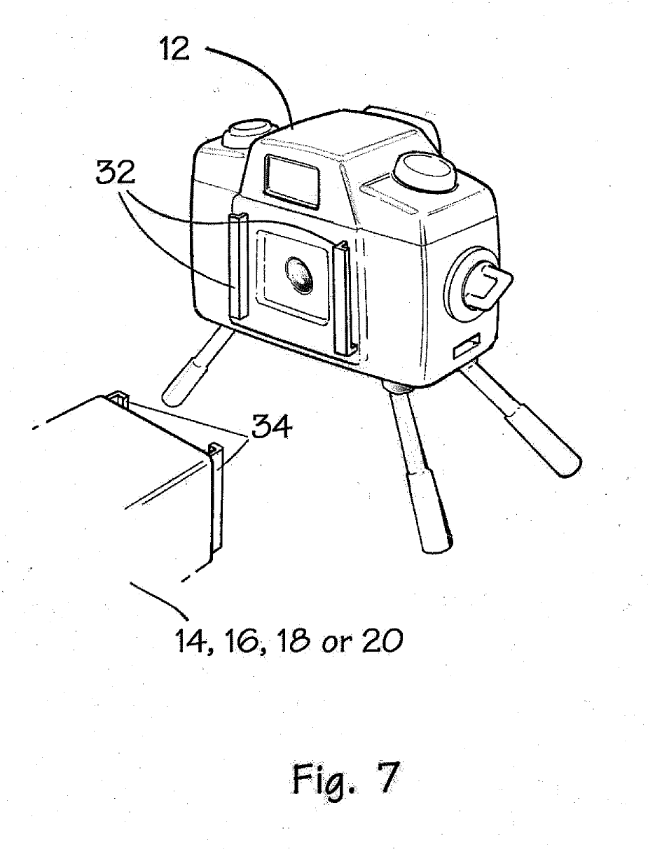

FIG. 7 is an alternate embodiment of a camera set that utilizes clips 32 and 34 to attach the camera 12 to an accessory 14, 16, 18, or 20. The clips 32 and 34 can be snapped together and subsequently pulled apart to attach and detach the camera 12. Although hooks 24 and clips 32 have been shown and described, it is to be understood that other attachment means such as magnets, buttons, VELCRO, etc. may be employed.

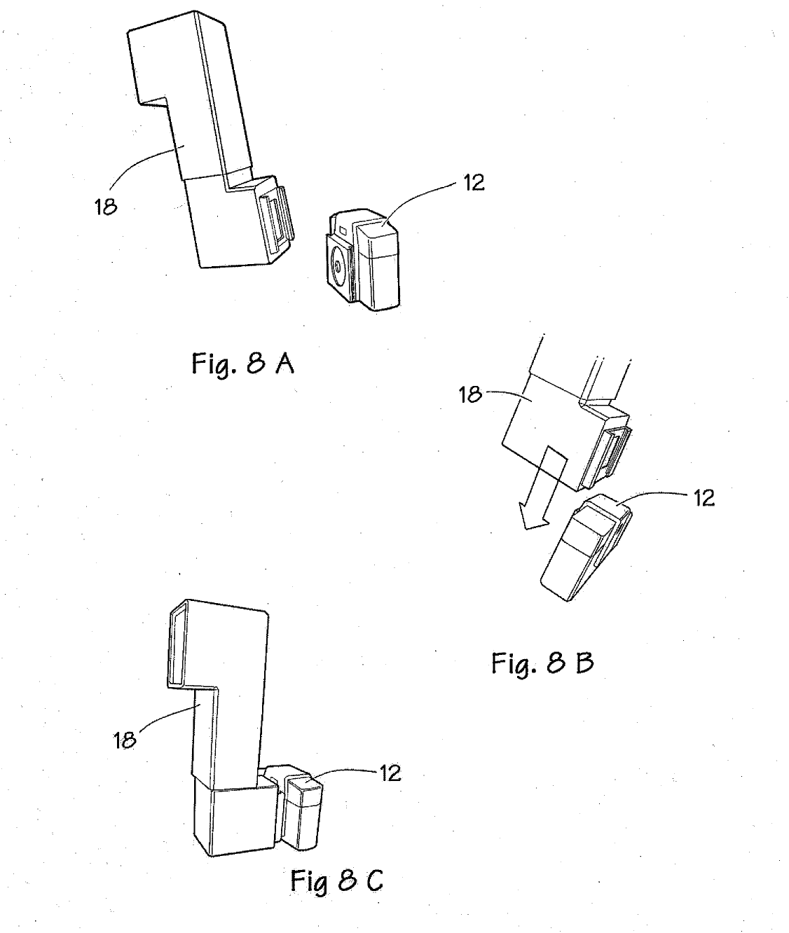

The camera kit 10 may include an instruction guide 36 that instruct a user on how to attach the accessories 14, 16, 18 and 20 to the camera 12. The instructions 36 may include text, illustration, photos, etc. that show how the various accessories can be attached and detached from the camera 12. For example, as shown in FIGS. 8A-C the instructions 36 may include photos that show how to attach the periscope 18 to the camera. The instructions 36 may also include the following text:
“(1.) Take the camera of the kit in one hand, and hold the periscope of the kit in the other hand. Align the rails of the camera with the corresponding grooves on the mounting area of the periscope.
(2.) Slide the two units into place, so that the grooves and rails are interconnected to provide a secure alignment of the two pieces.
(3.) Turn on the camera and take photographs, looking through the camera and observing the subject matter through the attached periscope. The periscope can be positioned to see over fences, or around doorways.”

Similar photographs and text can be provided to instruct the assembly of the other accessories to the camera.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A toy camera kit, comprising:
a box;
a camera located within said box;
a plastic toy microscope that is attached to and detached from said camera and located within said box;
a plastic toy binocular that is physically separate from said plastic toy microscope and is attached to and detached from said camera; and,
an instructions guide.

2. The toy camera kit of claim 1, wherein said camera includes a pair of slots that receive a plurality of snap on flanges of said plastic toy microscope and said plastic toy binocular.

3. The toy camera kit of claim 1, wherein said camera includes a digital image sensor.

4. A toy camera kit, comprising:
a box;
a camera located within said box;
a plastic toy microscope that is located within said box and that is attached to and detached from said camera;
a plastic toy periscope that is located within said box and that is attached to and detached from said camera;
a plastic toy binocular that is located within said box and that is attached to and detached from said camera; and,
an instruction guide.

5. The toy camera kit of claim 4, wherein said camera includes a digital image sensor.

6. A method for operating a toy camera kit, comprising:
providing a toy kit that includes a box that holds a camera, a plastic toy microscope and a plastic toy binocular;
removing the camera, the plastic toy microscope and the plastic toy binocular from the box;
reviewing an instruction guide;
attaching a plastic toy microscope to a camera;
taking a picture of an object in an image field of the toy plastic microscope;
detaching the camera from the plastic toy microscope; and,
attaching the camera to a plastic toy binocular that is physically separate from the plastic toy microscope.

7. A toy camera kit, comprising:
a box;
a camera located within said box;
a plastic toy microscope that is located within said box and that is attached to and detached from said camera;
a plastic toy periscope that is located within said box and that is physically separate from said plastic toy microscope and is attached to and detached from said camera; and,
an instruction guide.

8. The toy camera kit of claim 7, wherein said camera includes a pair of slots that receive a plurality of snap on flanges of said plastic toy microscope and said plastic toy periscope.

9. The toy camera kit of claim 7, wherein said camera includes a digital image sensor.

10. A method for operating a toy camera kit, comprising:
providing a toy kit that includes a box that holds a camera, a plastic toy binocular and a plastic toy periscope;
removing the camera, the plastic toy binocular and the plastic toy periscope from the box;
reviewing an instruction guide;
attaching a plastic toy microscope to a camera;
taking a picture of an object in an image field of the plastic toy microscope;
detaching the camera from the plastic toy microscope; and,
attaching the camera to a plastic toy periscope that is physically separate from the plastic toy microscope.

11. A toy camera kit, comprising:
a box;
a camera that is located within said box;
a plastic toy binocular that is located within said box and that is attached to and detached from said camera;
a plastic toy periscope that is located within said box and that is physically separate from said plastic toy binocular and is attached to and detached from said camera; and,
an instruction guide.

12. The toy camera kit of claim 11, wherein said camera includes a plurality of slots that receive a pair of snap on flanges of said plastic toy binocular and said plastic toy periscope.

13. The toy camera kit of claim 11, wherein said camera includes a digital image sensor

14. A method for operating a toy camera kit, comprising:
providing a toy kit that includes a box that holds a camera, a plastic toy binocular and a plastic toy periscope;
removing the camera, the plastic toy binocular and the plastic toy periscope from the box;
reviewing an instruction guide;
attaching a plastic toy binocular to a camera;
taking a picture of an object in an image field of the plastic toy binocular;
detaching the camera from the plastic toy binocular; and,
attaching the camera to a plastic toy periscope that is physically separate from the plastic toy binocular.
